(19) United States
(12) Patent Application Publication
(10) Pub. No.: US 2009/0247694 A1
(43) Pub. Date: Oct. 1, 2009

(54) SELF-HEALING ELASTOMER SYSTEM

(75) Inventors: Peter Kritzer, Forst (DE); Boris Traber, Ladenburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Carl Freudenberg KG, Weinheim (DE)

(21) Appl. No.: 12/412,925

(22) Filed: Mar. 27, 2009

(30) Foreign Application Priority Data
Mar. 28, 2008 (EP) 08005971.0

(51) Int. Cl. C08L 33/02

(52) U.S. Cl. 524/556

(57) ABSTRACT

A self-healing elastomer system is provided. The system includes an elastomer that has a surface and a core. The elastomer has an elastomer matrix. The elastomer matrix has first functional groups covalently bonded in the interior. A liquid phase borders on the surface of the elastomer. The liquid phase contains an additive. The first functional groups and the additive are chosen so that, in the case of damage to the elastomer, the first functional groups that come into contact with the liquid phase enter into a reaction. The invention also concerns methods for producing and using the self-healing elastomer system and suitable elastomers.

### FIELD OF THE INVENTION

The present invention relates to self-healing elastomers and elastomer systems, methods for producing them, and their use.

### BACKGROUND OF THE INVENTION

Elastomeric plastics can be damaged by external factors. Such damages is particularly problematic when the elastomers are used as seals and coatings. Elastomers can change their structure in an undesirable way, for example under the effect of elevated temperature, pressure, mechanical stress, the effect of chemicals like ozone, or external stress. In this case, surface damage, cracks in particular, can develop. After the occurrence of the first cracks or surface damage the material often is especially susceptible to further damage. For instance, an initially fine crack can become deeper with further stress and can lead to a situation where the material overall can no longer perform its function. For this reason, the seals or coatings have to be frequently checked and mended or replaced in many applications.

There were attempts to overcome these problems through the use of “self-healing” elastomers.

White et al. (Nature 2001, 409, 794-797) describes a method in which the components that are necessary for healing are incorporated into the matrix. One of the components is mixed into the elastomer in “encapsulated form.” A catalyst is incorporated into the polymer matrix as a second component. If there is damage (formation of a crack), the capsules open, causing the healing component to be released. A polymerization reaction that is supposed to lead to closure of the crack takes place in the presence of the catalyst.

WO2007/143475 describes self-healing elastomers, in which different filled capsules are embedded in the matrix. The first capsules contain a polymerizable material, while the second capsules contain a polymerization activator.

In these systems, all of the reactants that are involved in the healing reaction are incorporated in the matrix. Such systems have the disadvantage that, even with ordinary stresses and normal use, the microcapsules can open and the healing substance and reactive substance can react with each other. Seals and coatings in particular are frequently subjected to elevated pressure and mechanical stresses. Even the production of such materials involves mechanical stresses that can lead to undesirable opening of the capsules and to a premature reaction, for example in the case of mixing in a kneader, in rolling, extrusion or calendering. The encapsulated reactants and catalysts must remain stable during the entire elastomer production process, thus during mixing, vulcanization and postcuring at elevated temperature up to more than 180° C., at elevated pressure, and in the presence of radicals. Because of this, the choice of healing substances or healing substance systems (“capsules”) and catalyst systems is very limited. For example, the boiling point of the monomers that are intended to be caused to polymerize and in this way generate the “healing substance” must be above the vulcanization temperature, since otherwise, the capsules will burst.

Moreover, these capsules frequently must “survive” typical usage times of several years and still be able to develop their effect in a tailored way when required.

Another disadvantage of the known systems is that, when capsules are used, it is basically not possible for there to be a completely homogeneous distribution of the healing substances in the elastomer matrix. To achieve a distribution that is as homogeneous as possible, the capsules have to be particularly small and as many capsules as possible must be present. However, a high content of capsules has an undesirable effect on the properties of the elastomer. When choosing small capsules, it is disadvantageous that the resulting liquid volume decreases with the cube of the capsule radius. This means that even a small reduction of the capsule diameter involves a large decrease of the amount of reactants contained in it.

Moreover, when using capsules, it is important that the capsule material be compatible with the polymer material to a great extent. Otherwise, a uniform distribution of the capsules in the elastomer matrix will not be obtained, which can lead to a degradation of mechanical properties. If the distribution is uneven, there can also arise areas in the material for which there is no self-healing effect.

The healing substance is also released relatively “unspecifically,” since the amount released always can only be a multiple of the contents of a capsule. Thus, the same amount of material can be released when there is minor damage to the material as when there is considerably greater damage. It is also not always guaranteed that a fine crack will meet a capsule and open it. The healing mechanism also can only produce a one-time sealing of the crack, since no substances from outside reach the damaged site. Another disadvantage is that both the production of such filled capsules and their processing are costly and expensive.

### SUMMARY OF THE INVENTION

The invention is based on the task of making available a self-healing system that overcomes these disadvantages. A self-healing system that can be produced in a simple way and efficiently heals damages in the elastomers is to be made available.

The problem underlying the invention is surprisingly solved by a self-healing elastomer system, elastomers, processes, and uses in accordance with the patent claims.

The self-healing elastomer system in accordance with the invention consists of

a) an elastomer that has a surface and a core, where the elastomer has an elastomer matrix, where the elastomer matrix in the interior contains specific regions of covalently bonded first functional groups (H, as designated in FIG. 1), and optionally an additional catalyst that accelerates the reaction, and

b) a liquid phase that borders on the surface of the elastomer, where the liquid phase contains a special additive that likewise has specific functional groups (F, as designated in FIG. 1), where the first functional groups H and the functional groups F of the additive are chosen so that, in the case of damage to the elastomer, the first functional groups H of the matrix enter into a reaction with the functional groups F of the additive in the liquid phase. This reaction can also give rise to strong physical bonds in addition to chemical reactions.

The liquid phase borders on at least one surface of the elastomer. Under normal conditions, therefore in the absence of damage, it essentially is not in contact with the interior of the elastomer and with the first functional groups H. If there is damage to the elastomer or a separating layer between the elastomer and the liquid phase, the liquid phase penetrates undesirably into the interior of the elastomer and comes into contact with the functional groups H.

The elastomer consists of an elastomer matrix. This means a cross-linked polymer framework that has elastomeric properties. The elastomer can contain additional components that are not components of the cross-linked elastomer matrix. The elastomer can also be coated, for example with a separating layer that separates the liquid from the elastomer matrix. Within the scope of this application, such an arrangement is called “elastomer,” even if the separating layer itself does not consist of an elastomeric material.

The elastomer becomes stabilized by the reaction of the first functional groups H. The reaction essentially takes place selectively at the sites on the damaged surface of the elastomer that come into contact with the liquid phase. The reaction of the first functional groups H in this way at least partly brings about the self-healing of the system. Therefore, in accordance with the invention, it is also called the “healing reaction.” The damage or further damage is counteracted by the stabilization of the damaged elastomer, or the damage is remedied. “Self-healing” means that all components that are necessary for the healing reaction to take place are contained in the system in accordance with the invention. The reaction therefore can take place with no outside intervention. No components have to be added from outside, for example by a user or an apparatus. However, in accordance with the invention, this does not preclude that the system becomes modified from outside. For example, the additive can be added to a liquid phase after a particular stress or damage.

The damage can be any kind of adverse influence on the structure of the elastomer that causes the additive to come into contact with the first functional groups H. This is the case in particular when the liquid phase comes into contact with the interior of the elastomer or penetrates into the interior of the elastomer. This can take place when cracks arise in the elastomer or the surface becomes frayed or damaged. If the elastomer has a separating layer, the damage can also involve destruction of the separating layer.

The elastomer matrix contains first functional groups H in the interior. The functional groups can be covalently bonded to the elastomer matrix, but they can also be added to the elastomer compound as an additive or a supported filler material.

“In the interior” means that the elastomer has the first functional groups H in positions that, in an undamaged state, are not in contact with the liquid phase. However, this does not preclude that first reactive groups H are present on the surface of the elastomer. In this case, the surface of the undamaged elastomer must not contact the liquid phase. The elastomer can in this case have a separating layer that separates the elastomer matrix from the liquid phase.

If there is no separating layer, the surface of the elastomer can be pretreated so that functional groups H react with F at the surface. In another embodiment of the invention, the liquid phase contains an excess of the additive and does not react with the reactive groups of the surface until contact with the elastomer. There remains a stable self-healing system with reactive groups in the interior of the elastomer and additive in the liquid phase. The first functional groups are preferably uniformly distributed in the interior of the elastomer.

The healing reaction of the first functional groups H of the system takes place either with each other or with at least one additional reactant, the additive from the liquid, which has at least the second functional groups F. This reaction can be accelerated by a catalyst, which is added to the polymer matrix. The invention is based on the principle that at least one component that is necessary for the occurrence of the healing reaction is not contained in the elastomer, but rather is contained as an additive in the liquid phase.

In a preferred embodiment of the invention, the system contains a catalyst, which accelerates the reaction between the first functional groups H and the functional groups F of the additive, where the catalyst are parts of the polymer matrix, are covalently attached to them, are not covalently embedded in the matrix and/or are components of the additive.

Preferably, the self-healing elastomer system contains a catalyst that catalyzes the reaction, or a coagent that promotes the reaction. For example, the coagent can be a reaction accelerator or initiator. The catalyst and the coagent in this case can be the additive, can be a component of the additive, can additionally be contained in the liquid phase, and/or can be contained in the elastomer.

In one embodiment of the invention, the additive has second functional groups F, where the reaction of the first functional groups H of the elastomer matrix takes place with the second functional groups of the additive F. The system can additionally have a catalyst or a coagent that promotes the reaction. They can be present in the elastomer or in the liquid phase.

Each additive has at least one functional group F. If a single functional group per additive is present, the additives add to the elastomer as a consequence of the reaction. A layer or film arises, due to which further fraying of the elastomer is prevented. If there are two or more functional groups F per additive, a cross-linking can take place in the healing reaction. The additive can bond at least two different first functional groups H of the first phase together.

In one embodiment of the invention, the additive is a polymerizable monomer. The first functional groups of the elastomer matrix are addition sites for polymerization. The elastomer matrix contains a catalyst or a coagent that promotes the reaction, for example a reaction initiator or accelerator.

In another embodiment of the invention, the reaction of the first functional groups of the elastomer takes place with each other, for example, if the elastomer matrix contains uncross-linked double bonds. In this embodiment, the additive is preferably a catalyst or a coagent that promotes the reaction, for example a reaction initiator or accelerator, or a cross-linking agent.

In another embodiment of the invention, the elastomer has second functional groups that are covalently bonded to the elastomer matrix, where the reaction of the first functional groups of the elastomer matrix takes place with the second functional groups of the elastomer matrix. In this embodiment, the additive is preferably a catalyst or a coagent that promotes the reaction, for example a reaction initiator or accelerator, or a cross-linking agent.

In another embodiment of the invention, the elastomer matrix contains coagents that are not covalently bonded to the matrix and that have second functional groups, where the reaction of the first functional groups of the elastomer matrix takes place with the second functional groups of the coagents. In this embodiment, the additive is preferably a catalyst or a coagent that promotes the reaction, for example a reaction initiator or accelerator.

In another embodiment of the invention, the elastomer matrix contains a polymerizable monomer. The first functional groups of the elastomer matrix are addition sites for polymerization. The additive is a catalyst or a coagent that promotes the reaction, for example a reaction initiator or accelerator.

The reaction of the first functional groups of the elastomer matrix can be a chemical or a physical reaction. In the case of a chemical reaction, covalent bonds are formed. The functional groups enter into an interaction with each other or with additional functional groups, which leads to stabilization of the elastomer at the damaged site. The reaction can be the formation of covalent bonds or the formation of noncovalent interaction chosen from van der Waals, magnetic, electrostatic, ionic, hydrophobic, dipolar or other interactions.

In other embodiments of the invention, the functional groups and the additive are each magnetic and/or are each ionic and have an affinity for each other. If magnetic interactions are used, there is preferably a separating layer of a material that blocks the magnetic interactions present between the liquid phase and the elastomer. As soon as this separating layer is damaged and the elastomer is exposed, magnetic particles from the liquid phase can accumulate and seal the surface.

In one embodiment of the invention, permanent magnetic particles are present in the elastomer matrix, and a magnetic, but not permanent magnetic, powder is present in the liquid phase, where the powder can be as such or coated by the elastomer or polymers and where the average particle size of the powder is under 1 μm.

Table 1 shows exemplary embodiments of the invention.

TABLE 1
Self-healing concept

| Elastomer | Liquid phase | Type of reaction | Cohesive force |
|---|---|---|---|
| Two different | Catalyst | Catalyst triggers the | Covalent bond |
| functional groups A | | reaction of A with B | |
| and B | | in which a covalent | |
| | | bond arises | |
| Functional group A | Functional groups B | Catalyst triggers the | Covalent bond |
| and catalyst | | reaction of A with B | |
| | | in which a covalent | |
| | | bond arises | |
| Functional groups are | Cross-linking agent | Postcuring “as | Covalent bond |
| uncross-linked | | needed” | |
| fractions of elastomer | | | |
| Functional groups are | Adherent to matrix | Healing substance | Dipole/van der |
| not chemically | | forms an adhesive | Waals, magnetic or |
| reactive, but adherent | | film on the matrix | electrostatic |
| | | and thus prevents | interaction |
| | | further cracking | |

Suitable chemical reactions are, for example, polymerization, condensation, metathesis reaction, Diels-Alder reaction, allyl addition reaction and radical reaction. The functional groups are, for example, chosen from vinyl, diene, amine, alkoxysiloxane, carboxyl, hydroxy, urethane, isocyanate, siloxane, ester, amide and thiol groups.

Table 2 shows how the first functional group of the elastomer matrix H and the second functional group of the additive F can be chosen to obtain a chemical reaction between the elastomer and the additive.

TABLE 2
Self-healing concept by reactions with the additive

| First functional | Second functional | | |
|---|---|---|---|
| groups of elastomer | groups of additive in | Catalyst | Reaction |
| H | liquid phase F | or coagent | mechanism |
| C═C | S—H | Possible | Addition |
| R—S—S—R | | | |
| C═C | Diene bond | Optionally, | Diels-Alder |
| | | Cu catalyst | |
| | | or similar | |
| C═C | C═C | WCl₆ | Metathesis |
| Polyurethane, | —OH | Ti catalyst, | Condensation |
| carboxylic acid or | | DMAP | |
| siloxane Si(OEt)₃ | | | |
| Ester or amide | —COOH | Possible | Condensation |
| Ionic | Ionic | — | Salt formation |

The reaction is preferably a cross-linking reaction. The prerequisite for a cross-linking reaction is the presence of reactants (cross-linking agents) that have at least two reactive groups F in a molecule or on a particle. In a preferred embodiment, the additives serve as cross-linking agents.

Especially preferred is the use as additive of particles that have a plurality of second functional groups F. The particles can in this way be firmly bonded to the elastomer and prevent crack growth by bridge formation.

The elastomer can consist of known rubbers such as ethylene propylene diene rubber (EPDM rubber). EPDM rubber has high elasticity and good chemical stability, in particular with respect to polar organic media, and can be used over a wide temperature range. It is also possible to use rubbers chosen from natural rubber, isoprene rubber, butadiene rubber, chloroprene rubber, styrene-butadiene rubber or hydrogenated nitrile-butadiene rubber (HNBR). Homopolymers, copolymers or block copolymers can be used. Fluorinated or chlorinated rubbers such as perfluoro rubber (FFKM), fluorine rubber (FKM) or propylene-tetrafluoroethylene rubber (PTFE) and copolymers thereof can also be used. The elastomer can contain the usual added agents such as dyes, fillers, plasticizers, antistatic agents, antioxidants and rubber-specific cross-linking chemicals.

In a preferred embodiment, the additive consists of particles that contain the second functional groups F on the surface. The particles can consist of a support material, on the surface of which the second functional groups F have been deposited. An elastomer material is a possibility as support material. For example, elastomer particles that have OH groups on the surface (Micromorph™, RheinChemie, Rheinau) are suitable. Other suitable support materials are, for example, functionalized carbon blacks, graphite, carbon fibers, carbon nanotubes, silicic acids, aluminosilicates and mineral fillers. The use of particles is advantageous, since they can fill the cracks. The size of the particles is chosen so that they are capable of diffusing or migrating into cracks and closing the cracks by the reaction (or “pasting” the crack walls together). For example, elastomer particles, thermoplastic particles, carbon in particle, fiber or hollow fiber form, or other organic materials like silica, which have optionally been functionalized, can be used as support material. The average particle diameter of the particles can be <5, <3 or <1 μm. In preferred embodiments, the average particle diameter of the particles is 10 nm to 10 μm, in particular between 30 nm and 5 μm or between 100 nm and 3 μm. Preferably, the average measurement in at least two dimensions is less than 1 μm.

In a preferred embodiment of the invention the liquid phase contains cross-linkable additives with second functional groups F, and the elastomer matrix contains catalysts and/or reaction initiators or accelerators. These can be present in the matrix in pure form or in supported form. If they are in supported form, they can be incorporated into the elastomer on precipitated or pyrogenic silicic acids or carbon blacks.

Said catalyst or reaction initiator or accelerator can promote or initiate a reaction of the first functional groups H of the elastomer matrix with the additive. For instance, double bonds of the additive can react with the elastomer matrix or with reactive groups specially incorporated into the elastomer. The elastomer matrix can, for example, be derivatized with carboxylic acid groups (in carboxylated nitrile-butadiene rubber, XNBR). Also suitable are isocyanate groups or special cross-linking sites like haloalkane groups (—CH₂Cl or —CH₂Br) in fluorocarbon rubber (FKM) or polyethyl acrylate (ACM). It is also possible for the elastomer to contain functional groups that are not covalently bonded to the matrix, for example in the form of short-chain polymers (Nipol™, Zeon Chemicals, or Hycar™, Lubrizol Corp.). The first functional groups can be attached to the elastomer matrix by chemical reactions. It is also possible for a filler with the first reactive groups on the surface to be incorporated into the elastomer matrix. It can be bonded into the elastomer matrix, for example during vulcanization.

In a preferred embodiment, the system additionally has a separating layer that is situated between the elastomer and the liquid phase. In this case, the liquid phase does not directly contact the elastomer in the normal state, but rather the separating layer. The separating layer can be porous, provided the pore size is so small that the additive cannot diffuse into the elastomer. If there is damage to the separating layer, the underlying elastomer with the first functional groups H will be released, at least in part, and come into contact with the additive. For example, the separating layer consists of an elastomer. The same elastomer can be used as in the reactive elastomer component, provided a component that is necessary for the healing reaction is absent. For example, if the reaction requires a catalyst embedded in the elastomer matrix, the same elastomer as in the reactive elastomer phase can be used as the separating layer, but without the embedded catalyst. Also suitable is a protective varnish, for example an antifriction varnish.

In one embodiment of the invention, the elastomer additionally contains a coagent that is not covalently bonded to the elastomer matrix and that is involved in the interaction of the functional groups of the elastomer matrix and the additive. The coagent can be, for example, a catalyst, a reaction initiator, a reaction accelerator or a cross-linking agent. The liquid phase can, for example, be an aqueous phase or an oil phase, for example a lubricant. However, it can also contain other liquid components or consist thereof, for instance alcohols. Besides the additives that support the healing reaction, the liquid phase can contain other additives such as dissolved ions.

### BRIEF DESCRIPTION OF THE SEVERAL VIEWS OF THE DRAWINGS

FIG. 1 is a schematic drawing of an exemplary self-healing elastomer system in accordance with the invention in undamaged state.

FIG. 2 is a schematic drawing showing an exemplary self-healing reaction of an elastomer system in accordance with the invention in which a crack has developed in the elastomer.

FIG. 3 is a schematic drawing showing examplary self-healing in accordance with the invention of an elastomer upon damage to a separating layer.

### DETAILED DESCRIPTION OF THE INVENTION

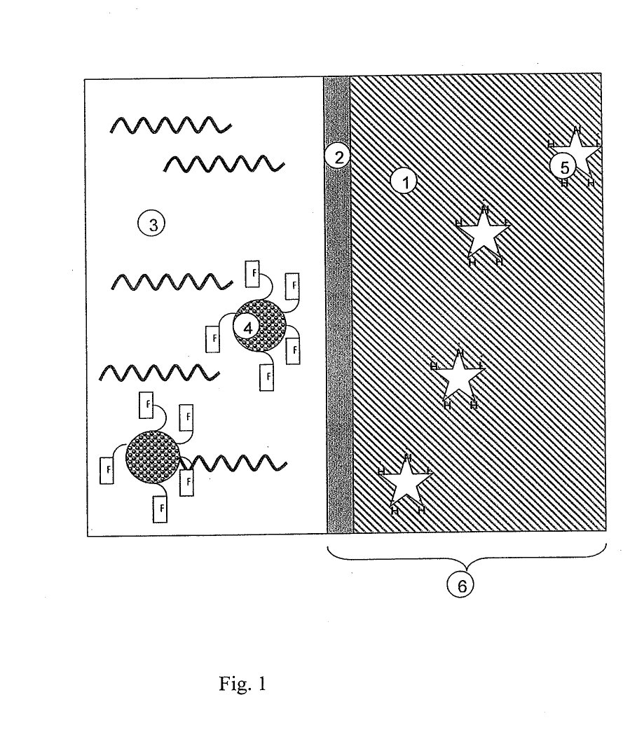

FIG. 1 shows a self-healing elastomer system in accordance with the invention in an undamaged state. The system contains an elastomer (6) with a cross-linked rubber (1). A separating layer (2) separates the liquid phase (3), which contains the additive (4), from the functional groups F in the elastomer. The separating layer (2) is applied by subsequent coating of the material. The separating layer (2) is created so that it cannot react with the liquid medium (3) or the functional groups H (5), and in addition, adheres well to the elastomer. The elastomer matrix (1) contains functional groups H (5) and can enter into a chemical or physical reaction with the functional groups F of the additive (4) or in their presence. The additive (4), which is added to the liquid medium, in FIG. 1 consists of particles of a support material and second functional groups (F) on its surface.

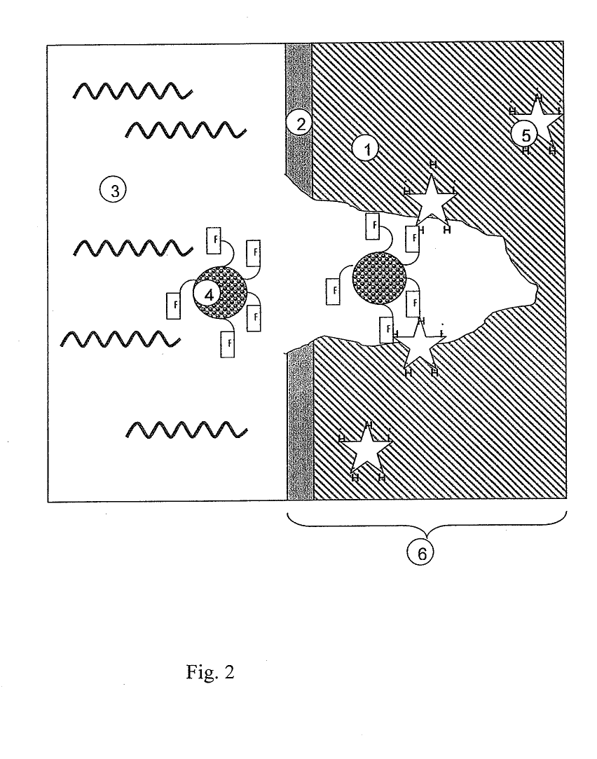

FIG. 2 shows the self-healing reaction of an elastomer system in accordance with the invention, in which a crack has formed in the elastomer (6). The crack goes through the separating layer (2), so that the liquid phase (3) comes into contact with the interior of the elastomer. The soluble additive is in the form of particles, in which the second reactive groups (F) are bonded to a support material (4). The soluble additives diffuse into the crack and react there with the first functional groups H (5) of the elastomer via the second functional groups (F). Through this, the particles become fixed in place in the crack, due to which the elastomer becomes stabilized and crack growth is stopped. Preferably, a cross-linking takes place in the reaction, in which more bonds are formed between an additive and the elastomer matrix.

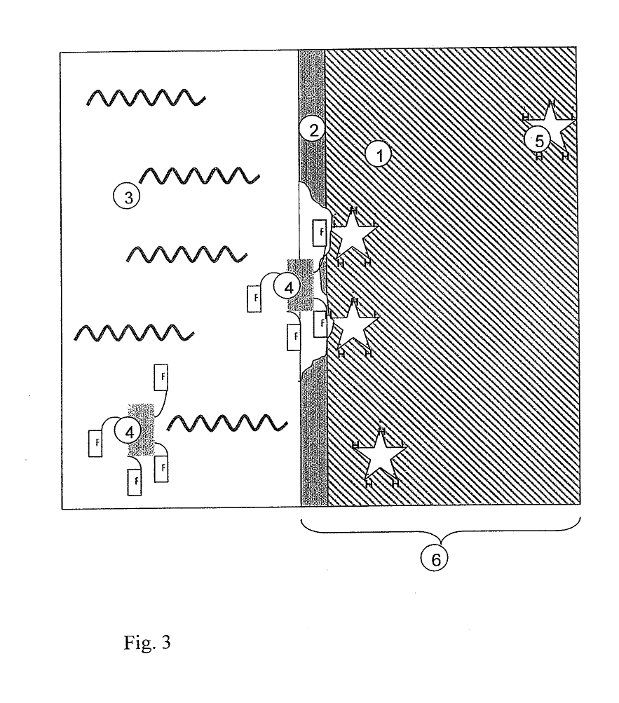

FIG. 3 shows an example of a self-healing in accordance with the invention of an elastomer (6) when a separating layer (2) has been damaged. The liquid phase contains monomer additives (3), which consist of the same building blocks as the polymer separating layer (2). In addition, the liquid phase contains particles (4) with the functional groups F. If the separating layer is damaged, for example by abrasion, then the functional groups of the elastomer matrix come into contact with the monomer additives (3) of the liquid phase. The monomer additives (3) react with functional groups H of the polymer matrix, for example with double bonds. Optionally, the reaction is supported by catalysts in the elastomer. Through this reaction, the open site is closed and the separating layer (2) is regenerated.

The elastomer in accordance with the invention, which optionally has the separating layer, forms a molded body. The molded body is preferably a seal or a coating. Seals and coatings are frequently in contact with liquids and are susceptible to damage such as cracks and surface damage. It is often difficult or complicated to detect such damage, and it can keep the seals or coatings from fulfilling their tasks, with the result of secondary damage. Preferably, the elastomer is a sealing ring, for example a rotary shaft sealing ring or O-ring.

Another object of the invention is an elastomer that has a surface and a core, where the elastomer has an elastomer matrix, where the elastomer matrix has in its core covalently bonded first functional groups H, and the elastomer has on the surface essentially no covalently bonded first functional groups H, where

(a) the elastomer matrix has second functional groups that are components of the elastomer matrix or are attached to them, and/or

(b) where coagents that have second functional groups, catalysts, reaction initiators, reaction accelerators and/or cross-linking agents are contained in noncovalently bonded form in the elastomer matrix, where the second functional groups, the catalysts, the reaction initiators, reaction accelerators and/or cross-linking agents are chosen so that they enter into or catalyze or initiate a reaction with the first functional groups H if one additional component penetrates into the elastomer.

In a preferred embodiment, the first functional groups are carboxyl groups, and a catalyst for an esterification is contained in the elastomer matrix. The elastomer can have a separating layer.

Another object of the invention is the use of the system in accordance with the invention or the elastomer for healing damage to elastomers.

Another object of the invention is a method for producing a self-healing elastomer system or for healing damage to an elastomer, where

(a) an elastomer is made available that has a surface and a core, where the elastomer has an elastomer matrix, where the elastomer matrix has first functional groups covalently bonded in the interior, and

(b) a liquid phase is added, which borders on the surface of the elastomer, where the liquid phase contains an additive,

where the first functional groups and the additive are chosen so that, in the case of damage to the elastomer, first functional groups that come into contact with the liquid phase enter into a reaction.

Another object of the invention is a method for producing a self-healing elastomer system or for healing damage to an elastomer, where the elastomer system

(a) has an elastomer that has a surface and a core, where the elastomer has an elastomer matrix, where the elastomer matrix has first functional groups covalently bonded in the interior, and

(b) has a liquid phase that borders on the surface of the elastomer,

characterized by the fact that an additive is added to the liquid phase, where the first functional groups and the additives are chosen so that, in the case of damage to the elastomer, the first functional groups that come into contact with the liquid phase enter into a reaction.

The system in accordance with the invention is self-healing. However, this does not preclude that the system can be modified from outside. Thus, it is possible in accordance with the invention to match the composition of the liquid phase to specific requirements or external conditions. For example, the additive can be added to the liquid phase at intervals in order to compensate a loss. The additive can also be added in a desired concentration only when there is a need. This can, for example, be meaningful if it has been established or it is possible that the elastomer is damaged, for example because of an elevated mechanical or temperature stress. It can also be routinely tested to see if there is still enough reactive additive present in the liquid phase. If necessary, the additive is then readded, or replaced, or the entire liquid phase with the additive is replaced.

The system in accordance with the invention has numerous advantages over the known systems. In the system in accordance with the invention, a reaction is initiated as soon as the liquid phase penetrates into the interior of the elastomer. It is not first necessary for a capsule to be ruptured by minimum mechanical stress. Thus, in accordance with the invention, crack growth can already be counteracted in an early stage of crack formation.

The invention enables high selectivity of the healing reaction by the completely spatial separation of one component of the healing reaction of the elastomer. The system reacts effectively at the site where the damage has occurred. A crack can be partly or completely closed. Nonspecific reactions do not take place at other sites in the elastomer. With the known systems that have capsules, nonspecific reactions can be triggered by damage to the capsules. Thus, in accordance with the invention, it is precluded that a reaction begins at a point in the elastomer at which the liquid phase has not penetrated into the interior of the elastomer.

The healing mechanism progresses via the interaction of a mobile component from the liquid medium with an immobile component of the rubber. In the case of the use of particles as soluble additive in accordance with the invention, a complete polymerization reaction is not necessary for healing of damage, but rather only the reaction at specific contact points. The particles then fill cracks or cover the damaged surface of the elastomer.

The invention enables the use of the healing reaction immediately upon occurrence of the damage, and at the site of the damage. The additive can develop its effect directly at the site of the damage. An undesired reaction does not take place either within the elastomer or in the liquid phase. In this way, there is neither an adverse effect on the elastomer phase due to inhomogeneities nor clump formation in the liquid phase. When there are cracks, cross-linking can take place from various sites on the crack surface. This “bridge effect” due to formation of a “molecular staple” prevents further spread of the crack.

### Embodiment Example

Composition of an elastomer system in accordance with the invention for a rotary shaft sealing ring in a lubricating oil.

The elastomer is composed as specified in Table 3. Examples 1 and 2 are in accordance with the invention. The control composition (left column) does not contain a catalyst, so the healing reaction does not take place.

TABLE 3
Composition of elastomer

| | | |
|---|---|---|
| Control | No. 1 | No. 2 |

| | | | | | | |
|---|---|---|---|---|---|---|
| Krynac 740 ¹⁾ | 100 | phr | 100 | phr | 100 | phr |
| Carbon black N 550 | 30 | phr | 30 | phr | 30 | phr |
| Dusantox IPPD ²⁾ | 2 | phr | 2 | phr | 2 | phr |
| Stearic acid | 2 | phr | 2 | phr | 2 | phr |
| Wingstay 29 ³⁾ | 1 | phr | 1 | phr | 1 | phr |
| ZnO₂ (70%) ⁴⁾ | 7 | phr | 7 | phr | 7 | phr |
| ZBECO-70 ⁴⁾ | 2 | phr | 2 | phr | 2 | phr |
| CLD ⁴⁾ | 1.5 | phr | 1.5 | phr | 1.5 | phr |
| Sulfur | 2 | phr | 2 | phr | 2 | phr |
| DMAP ⁵⁾ | | | 3 | phr | 5 | phr |

¹⁾ Carboxylated butadiene-acrylonitrile terpolymer from Lanxess
²⁾ Stabilizer, antioxidant
³⁾ Antioxidant
⁴⁾ Vulcanization accelerator
⁵⁾ Self-healing cross-linking catalyst

Mineral oil-based GE M1-220 N (Klüber Lubrications, Munich) is used as the standard lubricant oil for the rotary shaft sealing ring. 15 wt % Micromorph 20 is added to it as additive.

1. A self-healing elastomer system comprising:
an elastomer having a surface and a core, the elastomer having an elastomer matrix, wherein the elastomer matrix has first functional groups covalently bonded in the interior, and
a liquid phase that borders on the surface of the elastomer, the liquid phase containing an additive, wherein the first functional groups and the additive are chosen so that, in the case of damage to the elastomer, the first functional groups that come into contact with the liquid phase enter into a reaction.

2. An elastomer system as in claim 1, wherein the elastomer is stabilized by the reaction.

3. An elastomer system as in claim 1, wherein the system contains second functional groups that can react with the first functional groups, where the second functional groups are components of the elastomer matrix, are attached to it, are embedded in the matrix in a noncovalently bonded form and/or are components of the additive.

4. An elastomer system as in claim 1, wherein the system contains a catalyst, a reaction accelerator and/or a reaction initiator.

5. An elastomer system as in claim 1, wherein the additive has second functional groups, wherein the reaction of the first functional groups of the elastomer matrix takes place with the second functional groups of the additive.

6. An elastomer system as in claim 1, wherein the reaction of the first functional groups takes place with each other.

7. An elastomer system as in claim 1, wherein the elastomer system has second functional groups that are covalently bonded to the elastomer matrix, wherein the reaction of the first functional groups of the elastomer matrix takes place with the second functional groups.

8. An elastomer system as claim 1, wherein coagents that are not covalently bonded with the matrix and that have second functional groups are contained in the elastomer matrix, wherein the reaction of the first functional groups of the elastomer matrix takes place with the second functional groups of the coagents.

9. An elastomer system as in claim 1, wherein the reaction is the formation of covalent bonds or the formation of noncovalent interaction chosen from van der Waals, magnetic, electrostatic, ionic, hydrophobic, dipolar or other interactions.

10. An elastomer system as in claim 1, wherein the reaction is a cross-linking reaction.

11. An elastomer system as in claim 10, wherein the cross-linkable groups are chosen from vinyl, diene, amine, alkoxysiloxane, carboxyl, hydroxy, urethane, isocyanate, siloxane, ester, amide and thiol groups.

12. An elastomer system as in claim 1, wherein the additive consists of particles that contain second functional groups on the surface.

13. An elastomer system as in claim 1, wherein the functional groups and the additive are each magnetic and/or ionic and have an affinity for each other.

14. An elastomer system as in claim 1, further including a separating layer that is arranged between the elastomer matrix and the liquid phase.

15. An elastomer system as in claim 1, wherein the elastomer is configured as a seal, membrane, bladder, molded part, rubber-metal part, liner or hydromount.

16. A method for using the elastomer system of claim 1 to heal damage to elastomers.

17. An elastomer comprising:
a surface and a core,
an elastomer matrix having first functional groups covalently bonded in the interior with substantially no covalently bonded first functional groups on the surface, wherein:
(a) the elastomer matrix has second functional groups which are components of the elastomer matrix or are attached to it, and/or
(b) coagents that are not covalently bonded and that have second functional groups, catalysts, reaction initiators, reaction accelerators and/or cross-linking agents are contained in the elastomer matrix,
wherein the second functional groups, catalysts, reaction initiators, reaction accelerators and/or cross-linking agents are chosen so that they enter into or catalyze or initiate a reaction with the first functional groups if an additional component penetrates into the elastomer.

18. An elastomer as in claim 17, wherein the first functional groups are carboxyl groups and a catalyst for an esterification is contained in the elastomer matrix.

19. An elastomer as in claim 17, further including a separating layer.

20. An elastomer system as in claim 17, wherein the elastomer is configured as a seal, membrane, bladder, molded part, rubber-metal part, liner or hydromount.

21. A method for using the elastomer of claim 17 to heal damage to elastomers.

22. A method for producing a self-healing elastomer system comprising the steps of:
providing an elastomer that has a surface and a core, the elastomer having an elastomer matrix, the elastomer matrix having covalently bonded first functional groups in its interior, and
adding a liquid phase that borders on the surface of the elastomer, wherein the liquid phase contains an additive, the first functional groups and the additive being chosen so that, in the case of damage of the elastomer, first functional groups that come into contact with the liquid phase enter into a reaction.
